(19) United States
(12) Patent Application Publication
(10) Pub. No.: US 2002/0163495 A1
(43) Pub. Date: Nov. 7, 2002

(54) Multi-functional ergonomic interface

(76) Inventor: Plamen Doynov, Kansas City, MO (US)

Correspondence Address: LATHROP & GAGE, LC, Suite 2800, 2345 Grand Boulevard, Kansas City, MI, 64108, US

(21) Appl. No.: 09/847,083

(22) Filed: May 2, 2001

(51) Int. Cl. G09G 5/00; G09G 5/08

(52) U.S. Cl. 345/156

(57) ABSTRACT

A wearable control apparatus is provided for implementing desired user commands on an electronic device. The apparatus comprises a mounting frame for attaching to one or more of the user's fingers, various sensors for generating a command signal in response to user initiated input, and a physical link layer for performing processing on the command signals generated by the sensors and transmitting such processed signals to the electronic device to allow for control and navigation of such device. Preferably, the mounting frame is biometrically shaped to be ergonomically worn on the user's index finger or embedded in a “smart-glove”, such that the wearer's thumb can manipulate the sensors with minimal physical movement. The control apparatus can interface with the electronic device through a wire based or wireless connection, with an optional antenna for transmitting signals and power supply preferably attached to a user's wrist to maximize ergonomics and the range of use of the invention.

### BACKGROUND OF THE INVENTION

1. Field of the Invention

This invention relates generally to apparatus that can be worn on a user's body for interfacing with electronic devices, specifically for control and navigation of computers, personal digital assistants (PDAs), portable electronic devices, and other electronically controlled devices and, more particularly, apparatus for which minimal and ergonomically suitable physical movement, are sufficient to manipulate the apparatus and interface with the controlled devices.

2. Description of the Related Art

Control and interaction with electronic devices can be accomplished by numerous means, such as a mouse for personal computers, a joystick device for video games or robotics, or alphanumeric keypads with televisions, stereos, and similar devices. These controls allow users to interface with electronic devices from nearby and/or remote locations to communicate desired commands to be performed by such devices.

More specifically, it is known in the art to control a cursor on a computer display screen with a mouse. A user will typically move the mouse with their hand over a smooth, flat surface and displacement of the mouse will correspond with movement of the cursor on the computer display. Typically, a ball or contact roller located in the housing of the mouse will roll along the surface as the device is moved or, in the case of track-ball devices, the user directly rotates a ball housed in a stationary base. Sensors measure the rotation of the ball and generate a signal that is sent to the computer to cause movement of the cursor on the screen. Other mouse designs have an optical sensor that measures displacement of the device using optical principals. Additionally, most mouse-type devices have control buttons on the top of the housing that are actuated by a user's fingers. These control buttons allow the user to select icons and perform certain additional navigational functions on the computer screen.

A concern with the use of mouse-type or like devices is that it causes the user to position their hand and arm in an unnatural position that may lead to repetitive stress injuries. Also, typical use of the mouse requires the user to remove one hand from the keyboard each time the mouse is displaced or the control buttons are actuated, slowing down efficient operation. Although touchpads and similar input means have been integrated into the keyboards of laptop computers and similar electronic devices, these means do not alone provide all the features of a typical computer mouse without a user having to move their hand or fingers into multiple and usually awkward positions.

A similar need exists to control and navigate portable electronic devices, such as personal digital assistants (PDAs), personal communication systems (PCS), wearable computers, CD or digital music players, and similar devices. The Palm™ handheld by Palm, Inc. is an example of one of these devices. User's of PDAs often desire typical mouse functions that they are accustomed to on personal computers, but utilizing a bulky mouse with these relatively small devices would often be inconvenient and impractical. Further, it is desirable to control these portable devices remotely, such as a music player in a backpack or a wearable computer mounted on a belt, where it would be difficult for the user to initiate controls directly on the device with their hands or a stylus.

Still further, control of devices such as robotics and electronically-controlled machinery often require control means that are not configured for convenient portability and require significant movement by the user to carry out a desired task. These control apparatus are often bulky, not designed for a user to carry or transport easily, and are difficult to operate while performing other tasks. And, in adverse environmental conditions, such as hazardous weather, under water, or in space, where protective gear must be worn, the lost sensitivity of the user in handling the actuating means of a control apparatus significantly decreases the perceived functionality of the device to be controlled. In such situations the control devices typically have to be scalled up to compensate for the loss of sensitivity and resolution.

Also, an alternative control device is needed for people who have hand or wrist injuries, such as carpal-tunnel syndrome. The control of electronic devices may be painful for such people.

Technological advances have been made in an attempt to solve these problems. For instance, a finger-worn graphic interface device is taught by Levine, in U.S. Pat. No. 4,954,817, as being a replacement for a typical computer mouse. It requires a finger palette, a stylus ring and an electronic module that does not require the user to remove their hands from the keyboard to initiate normal mouse-type input commands. This design is itself somewhat cumbersome as the user must place the apparatus on two different fingers to operate. Also, such a design is uncomfortable to a typical mouse user as input into the device is provided by bringing together two artificial surfaces (stylus and the palette), instead of having the user's fingers or hand directly touch the surface of the control buttons on a mouse. Thus, it is difficult to judge location of the stylus and how much force or pressure is applied.

Further, Kent et al., in U.S. Pat. No. 5,706,026, claim a finger-operated digital input device that produces displacement signals in two dimensions as a function of the user pointing a finger at a surface. The device comprises a thimble worn on the end of a finger or attached to the end of a stylus, and a sensing means that measures displacement of the thimble relative to a surface. Such displacement of the thimble generates a signal adapted to control an external device, such as a computer. However, this device requires the user to rotate the thimble away from the finger whenever such a finger is needed to type on a keyboard, and rotate it back again to use the device. Further, the thimble must be displaced relative to a flat surface, so the user's hand must be moved or stretched a sufficient distance off of the keyboard so that a surface can be reached. This device appears just as inconvenient to use as a typical mouse.

Wang et al., in U.S. Pat. No. 5,832,296, attempt to overcome these problems through a self-contained, finger-wearable interface device that communicates with electronic devices. This device includes a variety of sensors, such as pressure and force sensors, as well as processing circuitry, a wireless transmitter and an optional receiver. The device resembles a ring and is adapted to be worn on a user's finger with sensors placed both on the inside and outside surfaces for actuation by a wearer's finger and thumb. The ring body serves as an omnidirectional loop antenna for transmitting and receiving signals. To operate the Wang device in a manner designed to emulate a computer mouse, the “clicking” or selection action of a mouse is performed by flexing or bending the finger on which the device is worn to actuate a pressure sensor.

Although the Wang et al. interface ring overcomes some of the above-described problems, this device has disadvantages when used to control many types of electronic devices. First, for efficient wireless operation and signal transmission to a device to be controlled, the invention in Wang would be too bulky to be formed as a ring-mounted device. This is because the interfacing device has the antenna, power source, and other components all mounted within a ring housing. And, as previously described, to effectuate the “clicking” or selection action of a computer mouse in the Wang device, the user is required to flex or bend the finger on which the device is worn to actuate a pressure sensor. Repetitive finger flexion is not a natural motion and places significant stress on the joints and ligaments of the user's finger. This may lead to repetitive stress injuries such as carpal tunnel syndrome.

Thus, what is needed is a device for control and navigation of an electronic device in a simple and ergonomic design. For a computer application, such a design should ideally allow a user's hands to remain on the keyboard while input commands are applied to the device. Such a device should manipulate the functions that can be performed on a typical mouse-type device, but be adapted to reduce repetitive motion fatigue. Further, the device should be operable by people having sustained injuries, such as carpal-tunnel syndrome, to enable their control of electronic devices.

The device may also allow for a configuration of the sensing means that is best suited for a particular application. For instance, potential uses include automobile applications where the driver can navigate onboard equipment without removing the driver's hand from the steering wheel, and applications where the device can be integrated into a “smart glove”, such as for environmentally challenging situations, to increase the functionality of operation.

### SUMMARY OF THE INVENTION

A control apparatus for implementing desired user commands on an electronic device comprises a mounting frame for attachment to a user's finger, one or more sensors for generating signals in response to user-initiated input, and a Physical Link Layer for receiving and performing processing on signals generated by the sensor and transmitting such processed signals to the electronic device to allow for control and navigation of such device.

The mounting frame is configured to be worn on the finger of a user's hand and has sensors attached to the frame in such ergonomic positions as to allow the user to operate the apparatus with their thumb alone, or in combination with another finger. The sensors can be position, displacement, force, pressure, or other similar sensors that receive input from a user and generate a signal corresponding to that input that is subsequently processed for controlling the desired electronic device. The Physical Link Layer connects with the sensor and provides the processing means for the signal generated by the sensor.

Depending on the type of application and the proximity of the control apparatus to the device to be interfaced with, the Physical Link Layer can be a wire-based connection or a wireless connection, such as a radio frequency or optical communication means. In the case of a wire-based connection, the physical link layer also provides a power source and a wiring scheme for physically connecting the apparatus to the device to be controlled and transporting the transmitted signal to such device. Alternatively, in a wireless implementation, the physical link layer provides a power source, a transmitter and, for a radio frequency communication means, an accompanying antenna for sending processed signals to the electronic device. Preferably, in a wireless configuration, the power source and optional antenna are attached to a wrist-mounted device, which is connected to interface by an appropriate wiring scheme, such that the user has a less restrictive and more ergonomic movement while using the control apparatus.

Software is provided with the device to ensure processed control signals are compatible with existing or future operating systems (OS) and embedded applications. The software also provides for flexibility of operation and multi-functional use of the device. An optional data link layer is integrated into the present invention for implementing a coding technique to ensure that multiple users of the control apparatus do not interfere with each other while operating in close proximity.

The apparatus allows the user to perform typical computer mouse functions, such as scroll, click, double click, drag, drop, and all other applicable functions, with a minimal amount of physical movement on the user's part, eliminating the need for removing hands from the keyboard. In other applications the user can perform multiple tasks at once, as the unobtrusive nature of the apparatus allows the wearer to control a device while continuing to focus attention on other objects held in the wearer's hands or near the wearer's fingers. For example, an astronaut in space could implement a command on the device to open a cargo door at a remote location while continuing to handle tools or other objects necessary to complete another task. This control functionality is accessible while wearing the mandatory, typically bulky protective gloves. The user can move his fingers internally of the glove to use the interface and thus effectuate a command to the remote object (i.e., open cargo door).

The apparatus also can be configured with sensors that are easily operated by a sense of “feel”, such that the wearer would not have to look at the device while using their fingers to direct a command, leaving them free to visually focus on the device to be controlled or any other object. In another embodiment, the device is not mounted directly on the finger of the user, but is built into a “smart-glove” device that is worn by the user. The input sensors of the device would still operate by being actuated by the wearer's finger or thumb, but the multi-functional interface is ergonomically embedded into the glove. Also, the apparatus serves to control not only pure electronic devices, but mechanical devices that are controlled by electronic circuitry and adapted to receive a signal from the control apparatus.

The present invention provides a control apparatus with improved ergonomics and complete portability for ease of use with a wide variety of electronically controlled devices. The apparatus is easily configured with appropriate sensors for the most efficient use based on the desired application, and can be designed to be expandable to allow the user to add additional sensors in the future. By requiring only a limited amount of physical movement to interface with an electronic device, the apparatus allows the user to efficiently perform multiple tasks at one time.

It is therefore an object of the present invention to provide:

a control apparatus for implementing a variety of commands on an electronic device. It is a further object of the present invention to provide such a apparatus with input sensors configured for ease of use with a desired application or device, and to provide such a apparatus that is comfortable to wear and ergonomically designed to reduce fatigue from use; providing such a apparatus that requires a minimal amount of physical movement to generate an input command to control a device. I t is a further object of the present invention to provide such an apparatus with a three-dimensional control interface to provide three-dimensional control of an electronic device.

It is yet another object of the present invention to provide a apparatus having a control apparatus that is accessible and operable while simultaneously performing an alternate task (e.g., typing and mouse operation).

It is a further object of the present invention to provide an apparatus that can provide stimulus to a wearer for stimulus-response testing for physiological evaluation.

Other advantages and components of the present invention will become apparent from the following description taken in conjunction with the accompanying drawings, which constitute a part of this specification and wherein are set forth exemplary embodiments of the present invention to illustrate various objects and features thereof.

### BRIEF DESCRIPTION OF THE DRAWINGS

FIG. 1 is a perspective view of a interfacing control apparatus according to the present invention.

FIG. 2 is a perspective view of the present invention showing a wireless physical link layer as used with a P.C. while the user operates a keyboard simultaneously.

FIG. 3 is a perspective view of the interfacing control apparatus according to the present invention.

FIG. 4 is a perspective view of another embodiment of the present invention showing a joy-stick input sensor with switches positioned adjacent the joy-stick.

FIG. 5 is a perspective view of another embodiment of the present invention showing the configuration of the capacitive coupling position/direction input sensor.

FIG. 6 is a perspective view of another embodiment of the present invention showing a configuration of a three-dimensional position/direction sensor having switches positioned in the corners.

FIG. 7 is a perspective view of an embodiment of the present invention showing a remotely powered control interface.

FIG. 8 is a perspective view of another embodiment of the present invention showing a physical link layer for a personal computer. FIG. 9 is a perspective view of another embodiment of the present invention showing a wireless physical link layer for a personal computer with a receiving antenna mounted on the keyboard.

FIG. 10 is a perspective view of a glove-mounted interfacing control apparatus of the present invention.

FIG. 11 is a block diagram of the interfacing control apparatus according to the present invention.

### DETAILED DESCRIPTION OF THE INVENTION

5 An interfacing control apparatus in accordance with the present invention is shown generally at 10. The interfacing control apparatus 10 comprises generally a mounting frame 11, a sensing means 12, and a Physical Link Layer 13 (PLL) for receiving user input commands, generating and processing a signal based on those commands, and transporting such signal to a device to be controlled.

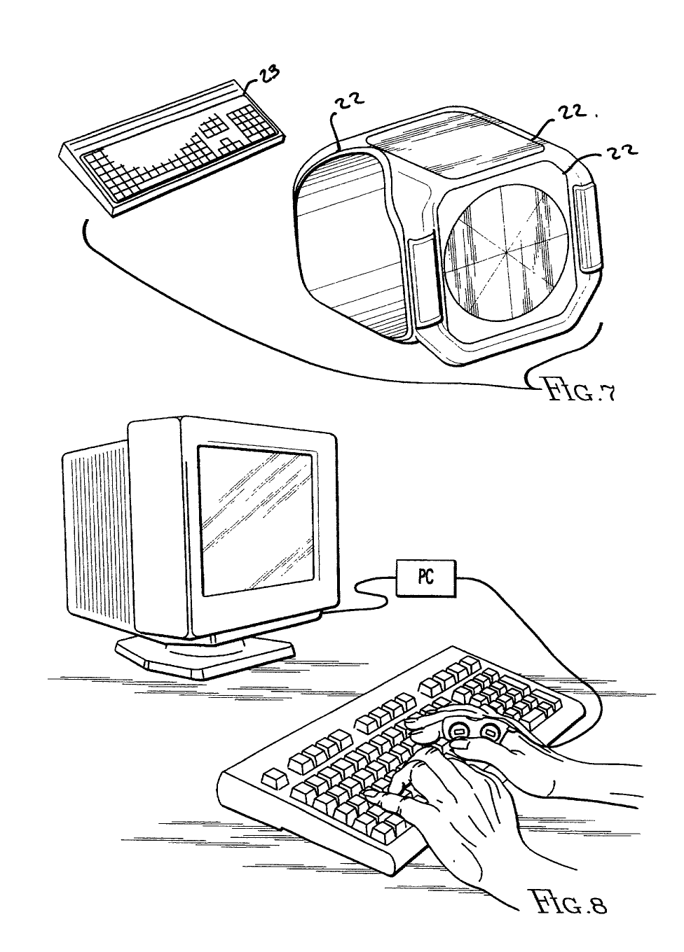

The mounting frame 11 provides a stable and convenient housing for the sensing means 12 and interfaces directly with the PLL 13. The control apparatus 10 is designed and configured to be worn by the user in a position that allows for ease of manipulation of the sensing means 12 by the wearer's fingers and/or thumb. Preferably, the mounting frame 11 is adapted to be mounted on a user's index finger such that the wearer's thumb and/or adjacent fingers can easily actuate the sensing means 12 to select a desired command to be carried out on the controlled device. For example, if the device is mounted on the user's right index finger, the sensing means can be located on the side of the mounting frame 11 directly adjacent to the right thumb to allow for direct manipulation of the sensor. As shown in FIG. 6, the device can likewise be made for a left-handed person. Preferably, the other components of the control apparatus 10 are not affixed to the mounting frame 11, but are located on the PLL 13 at a location on the user that does not interfere with the functionality and ergonomic design of the apparatus, such as on a wrist-mounted support strap.

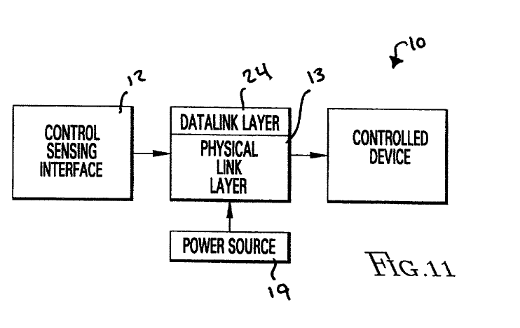

Other embodiments of the present invention may utilize a mounting frame 11 that varies from the finger-mounted, ring-type device described above, such as a “smart-glove” embodiment (FIG. 10) that affixes the frame and sensing means on the outside of a glove worn on the user's hand.

The sensing means 12 comprises a position/direction input sensor 14 and a plurality of switches 15 that the user touches or manipulates to enter a desired command. Sensing means 12 further includes sensing electronics that generate a control signal based on the type of input received by the control-button 14 and electrically communicate the signal to the PLL 13. The sensing means 12 can be any known in the art for receiving user input, such as position or displacement sensors based on resistive, capacitive, force pressure or other sensing methods. Ideal position sensors include joy-stick type devices, track-ball type devices, and devices implementing rotating cylinders or concentric rings. By placing multiple sensors on the mounting frame 11, the user can initiate multiple commands simultaneously, such as two-dimensional movement control while initiating a click command or selection action through switch 15. However, only one sensor needs be actuated to initiate many available commands. Again, the sensors are ergonomically positioned to allow the user's fingers to easily reach and initiate a command on the sensor without undue strain or significant physical movement.

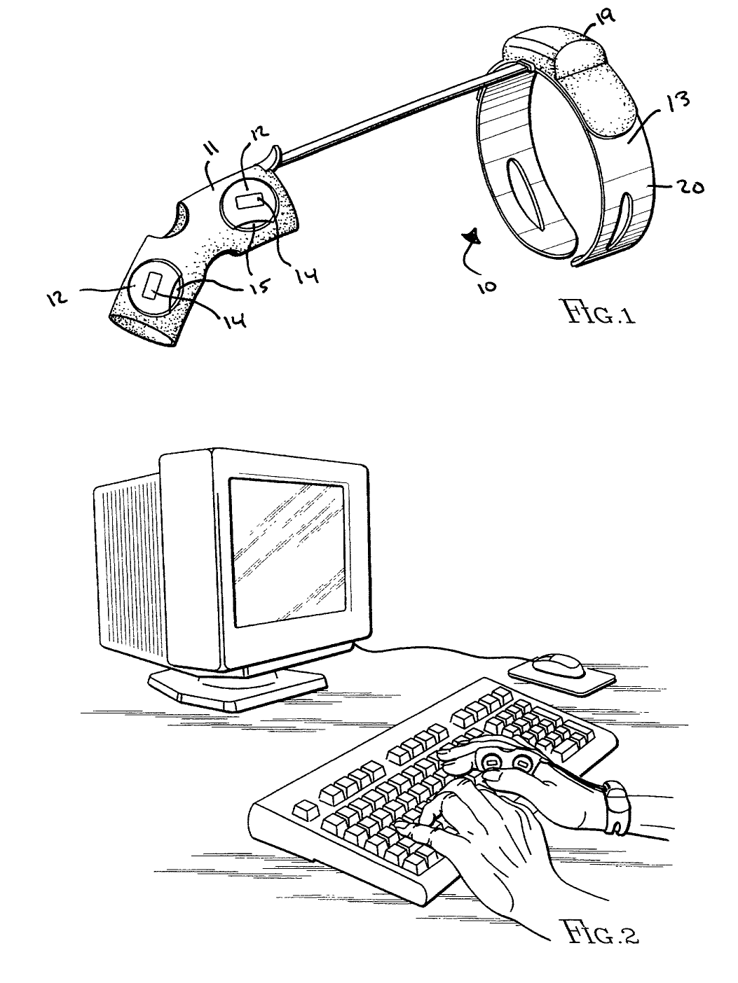

The PLL 13 is broadly defined as a component of the apparatus for receiving the signal communicated by the sensing electronics 15 of the sensing means 12, processing the signal, transporting the signal to an electronic device to be controlled, and providing the appropriate power source and mounting structure for accomplishing these functions. The PLL 13 provides the interface between the sensing means 12 and the controlled device. Preferably, and as shown in FIG. 1, the PLL includes a link that transfers the data from the sensing means to a bracelet 20, which houses other components of the interfacing control apparatus. The PLL can be incorporated in a clip-on housing and attached independently.

In a wireless PLL embodiment, transmission of command signals from the control apparatus 10 to the device to be controlled is accomplished by a wireless link means. A microcontroller conditions the processed signals for transmission at the appropriate frequency and emits a signal that is received by the electronic device through a wireless connection. The microcontroller is embedded in the mounting frame 11 along with the sensing means 12, or can be positioned at another location on the PLL 13, such as on a wrist mounted device 20. A wrist-mounted microcontroller has the advantage of being less restrictive with respect to the volume and weight, and further enables the use of a high-capacity power source for extended duration of use and extended range of remote operation.

FIG. 8 shows an embodiment of the present invention in which a wire-based connection is used to transmit signals to the electronic device. In this configuration, command signals are transported from the transmitter 17 to the controlled device through a wiring scheme 18 that directly connects the control apparatus 10 and the controlled device. In this wiring scheme, the wire based connection supplies power to the control apparatus 10. This link is preferably releasably mounted to the mounting frame to enable the user to disconnect this link and freely move in their environment.

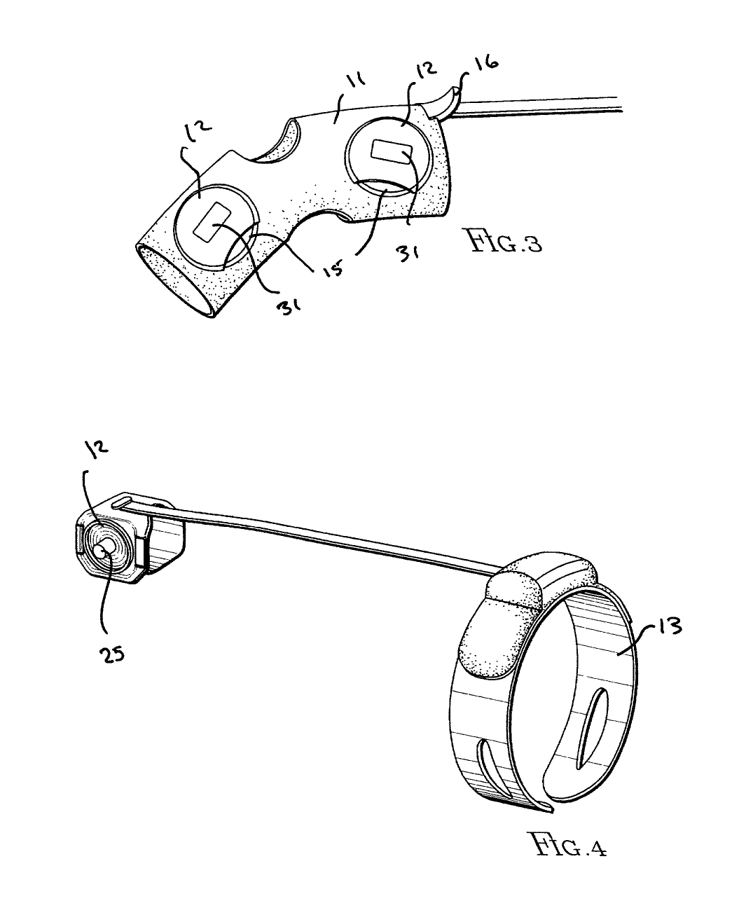

In an alternative embodiment, FIG. 2 shows a wireless connection for the PLL 13 wherein signals are communicated to the electronic device through a suitable electro-magnetic field without requiring a direct physical link of the invention to the device to be controlled. For example, a radio frequency or optical signal based on the processed signal can be generated by the microcontroller 17 and sent to a receiving means 21 of the controlled device for implementing the command.

In the configuration implementing a radio frequency (RF) wireless connection shown in FIG. 9, a transmitting antenna 22 is connected to the microcontroller and emits a signal received from the microcontroller to the receiving means 21 of the controlled device. As an example of using the present invention with a personal computer (PC), the receiving means 21 of the PC can be a receiving antenna 23 that is attached a keyboard of the PC such that antenna 23 transmits the received signal to the PC through a Universal Serial Buss (USB) connector available on current keyboards. In this configuration, only a very short transmission range would be necessary to operate the invention with a personal computer.

The transmitting antenna 22 of the micro-interface is preferably attached to the wrist mounted bracelet 20, which provides two distinct advantages. First, the antenna 22 can be of a sufficient size and gain as to allow for transmission of signals at higher power, which would be difficult if the antenna were housed within the mounting frame or ring 11. This further increases the range of operation for the control interface 10. For example, this provides the invention to be used during presentation in an auditorium.

The power source 19 for providing electrical power to the control apparatus 10 is electrically connected to the components of the control apparatus and is preferably attached to the wrist mounted device 20 to allow the user to have less restrictive and more ergonomic movement while using the present invention. In one embodiment, the power source is a battery to provide the electric power for the micro-interface. The battery may be rechargeable or alternatively a disposable battery.

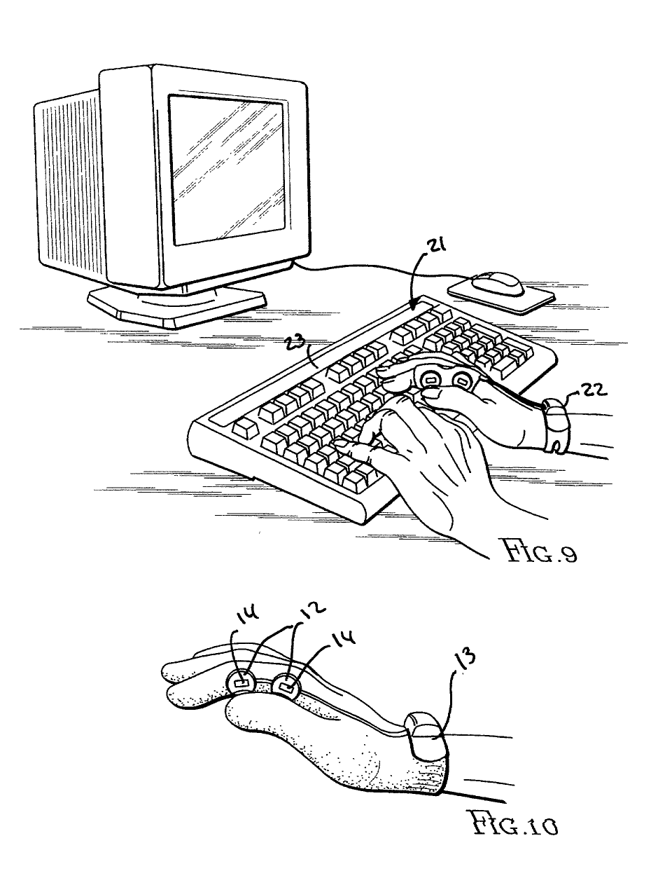

In a preferred embodiment of the wireless PLL connection (FIG. 7), the interfacing control apparatus of the present invention may be powered by means of wireless transmission of energy from the antenna associated with the controlled device (i.e, antenna 23 in the case of a PC), which acts as a primary winding. A coupling receiving antenna 22, which acts as a secondary winding, receives the electrical energy through electromagnetic induction to provide the necessary energy for operation of the sensing means 12. A power forming circuit is created between the interface control apparatus 10 and the keyboard and thus eliminates the need for a separate power source in the interfacing control apparatus. Preferably, and as shown in FIG. 7, the interface control apparatus is equipped with 3 coupling receiving antennas 22. The antennas are orthogonal to each other and this ensures that regardless of the user's hand orientation, the interface control apparatus is being sufficiently energized to operate.

Alternatively, the optical wireless connection configuration would perform the same function as the RF wireless connection but would substitute an optical signal transmitter and optical signal receiver in place of the transmitting antenna 22 and receiving antenna 23, respectively. An optional feature for the wireless connection embodiment of the invention includes a data link layer 24 (DLL) coupled to the microcontroller as shown in FIG. 11. The DLL 24 implements a coding technique to ensure that the transmitted signal does not interfere with other users of the present invention while in close proximity to each other.

The present invention has numerous embodiments. FIG. 3 shows a mounting frame 11 and sensing means 12 configuration comprising the rotational input sensor 31. The mounting frame 11 of the sensor 31 is designed to fit over the finger with a sleeve-type design that straddles one of the joints of the wearer's finger. The mounting frame may be formed with a lip or tab 16, as shown in FIG. 1, to facilitate mounting of the mounting frame on the user's finger. The frame 11 adjacent the user's thumb has two or more rotating barrels sensors that generate a signal based on the degree of rotational displacement. Frame 11 further includes a pair of switches 15 to allow for selection commands, for example, as explained above, other sensors could be mounted on the frame 11 to expand the invention's control and navigational abilities and impart mouse-type functionality.

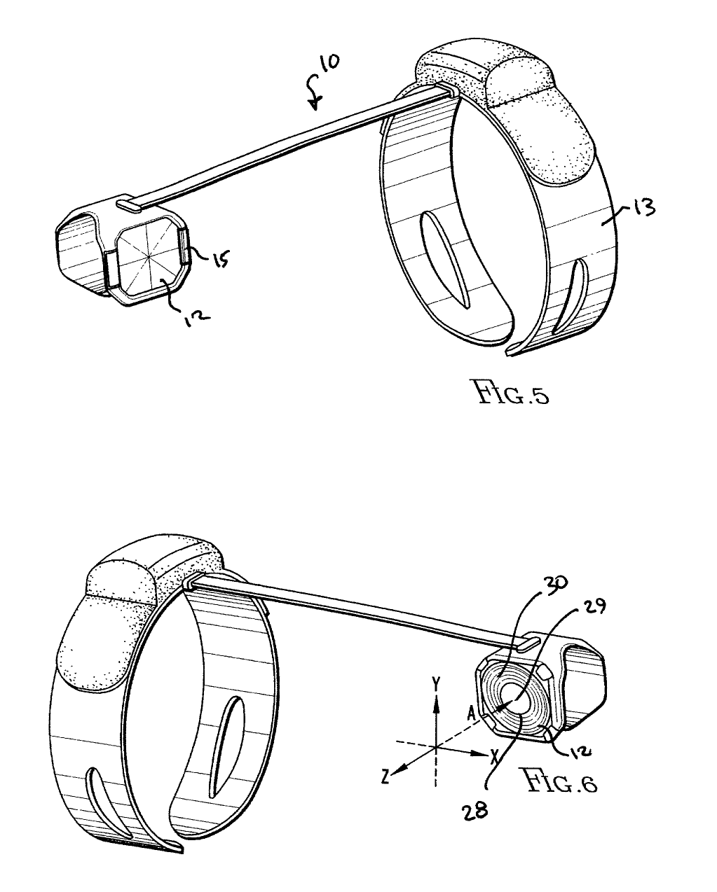

FIG. 4 gives a representation of the joy-stick input sensor 25 that generates signals based on the position of the stick 25 relative to a neutral position. When the mounting frame 11 is worn on a user's index finger, the sensor 25 is easily manipulated in two dimensions by the wearer's adjacent thumb of the same hand to generate a signal for controlling an electronic device. The stick 25 extends generally in the horizontal plane in the direction of the user's thumb to ensure the most ergonomic position of operation. As an example of how this sensor would be used, a cursor can be moved in any direction on a computer screen with the joy-stick, or an address book on a personal digital assistant can be scrolled and selected. Further, the stick 25 can be adapted to be clicked or depressed to add another input element and give the interfacing control apparatus 10 true computer mouse-type functionality. Alternatively, other sensors could be mounted adjacent to the joy-stick sensor 25 to increase the invention's control and navigational abilities and impart mouse-type functionality.

FIG. 5 discloses the control interface apparatus of the present invention with a capacitive coupling position and direction sensor. For this sensor, placement of the user's finger covering at least a portion of two sectors will alter the electronic condition of the sensor through capacitive coupling of the adjacent sectors. For example, for a personal computer this change in condition will correspond to a correlated directional motion of the cursor on the screen.

FIG. 6 shows another sensor embodiment for a three-dimensional sensor input 28 that is mounted to the mounting frame 11 and is disposed between a user's index finger and thumb. To actuate the sensor, the user can move their thumb along the sensor face 30. The sensor 30 responds to the relative position of the wearer's thumb in two dimensions with respect to a reference coordinate system. The user can also depress the sensor button 29 with their thumb while the index finger supports the sensor on a side opposite the thumb. As examples of devices that can be controlled in this manner, movement of the thumb in a direction normal to the sensor's surface would impart a three-dimensional navigation on a display screen of a personal computer, or three-dimensional movement of an actuating arm of a robot. Further, FIG. 6 discloses that the control interface apparatus of the present invention can be made for left-handed operation as well. Other sensors could be combined to create additional functionality, as explained above.

In an alternative embodiment of the present invention, the control apparatus 10 further includes authentication means for the users of the controlled device. In this embodiment, the control apparatus 10 includes an embedded “burned-in” Identification Code (IC). The controlled device has preset information for a particular code or list of codes and responds to commands issued from a control apparatus with an IC in this preset list. The antenna within the control device 10 receives predefined signals from the controlled device whereby the controlled device tags the control device 10 (possibly intermittently) to insure authentication of the user. Conformation with a valid IC response results in establishing and/or continuation of communication and operation of the controlled device. This provides a security system in which the user of control device 10 may leave the work area and be confident that only authorized users may have access to the work station. Thus, this eliminates the need for a password or provides an additional level of protection and securities with a single or multiple user access. Furthermore, this can be used as a key that enables additional user interface (i.e. the keyboard).

This authentication functionality is transparent to the user and provides for secure operation while using the control apparatus of the present invention. The IC is hardware and/or software implemented and is capable of being updated and is readily integrated with previously established protocol.

In another application of the present invention, the interfacing control apparatus is further provided with interactive stimulus means to generate sensations to the user. Specifically, the interface can be used for biomedical physiological purposes, as previously described. Further, the interfacing control apparatus may be used in interactive applications such as games. In these applications, the interfacing control apparatus is formed with transducers to provide stimulus and generate sensations to the users. The PLL is in communication with the controlled electronic device and receives commands therefrom to operate the transducers. In this application, any one or more of the aforedescribed embodiments may be used in the stimulus-providing application.

In addition to the applications described above, the current invention also provides a means of interfacing with many other electronic devices. The interfacing control apparatus is an ideal navigational tool for Head Mounted Display Units (HMDs) that utilize a computer and/or microprocessor to control operation, as well as Wearable PC using a variety of display methods. Carrying around a typical computer mouse to use with these devices would be cumbersome and a suitable surface for mouse operation is difficult to find when the user is moving from location to location. Also, embedding the current invention into a weather-proof “smart glove” would allow for remote control of a device in environments where protective gear is a must, as for an astronaut in space, a diver under water, or a firefighter in a smoke-filled building. From the forgoing information, it should now be obvious that the interfacing control apparatus 10 provides a more ergonomic, universally compatible solution for interfacing with a variety of electronic devices. The present invention can also be configured to optimize the functionality of the control apparatus 10 depending on the device that is desired to be controlled and navigated. It is to be understood that the present invention can be used to control devices in addition to those disclosed herein, as future electronic device applications will necessitate the use of the control apparatus for interfacing. It will be understood that a device according to the present invention can be used under (inside) the protective gloves. Furthermore, while certain forms of the present invention have been illustrated and described herein, it is not to be limited to the specific forms or arrangement of parts described and shown.

What is claimed is:

1. A control apparatus for implementing user commands on an electronic device, the control apparatus comprising:
a mounting frame for attachment to a user's hand;
at least one sensor coupled to the mounting frame for generating signals in response to a user-initiated input received by the sensor; and
a physical link layer located remotely of the mounting frame, the physical link layer being in communication with the sensor and interfaced with an electronic device, wherein the physical link layer receives signals generated by the sensor, processes the signal for compatability with the electronic device and transmits such processed signals to the electronic device to allow for control and navigation of such device.

2. The control apparatus of claim 1 wherein the sensor comprises a position sensitive sensor.

3. The control apparatus of claim 1 wherein the sensor comprises a force sensitive sensor.

4. The control apparatus of claim 1 wherein the mount ing frame is operably configured to be worn on one or more fingers of the user's hand.

5. The control apparatus of claim 1, wherein the physical link layer comprises:
a microcontroller in communication with the at least one sensor, the microcontroller receiving command signals from the at least one sensor and performing control processing on the signals;
a radio-frequency transmitter in communication with the microcontroller for transmitting the processed command signals to the electronic device;
an antenna in communication with the transmitter for transmitting the desired command signal to an electronic device located at a remote distance from the control apparatus;
a power source for providing electrical power to the components of the control apparatus; and
a mount for attaching the physical link layer to a user's body in a location remote from the mounting frame, wherein the antenna and power source are positioned on the mounting.

6. The control apparatus of claim 1, wherein the physical link layer comprises:
a microcontroller in communication with the one or more sensors that receives command signals from the one or more sensors and performs control processing on the signals to ensure that the electronic device recognizes the command signal;
an optical transmitter in communication with the microcontroller for transmitting the processed command signals to the electronic device through a generated optical signal;
a power source for providing electrical power to the components of the control apparatus; and
a mount for attaching the physical link layer to a user's body in a location remote from the mounting frame, wherein the power source is attached to the mounting means.

7. The control apparatus of claim 1, wherein the physical link layer comprises:
a microcontroller in communication with the one or more sensors that receives command signals from the one or more sensors and performs control processing on the signals to ensure that the electronic device recognizes the command signal;
a transmitter in communication with the microcontroller for transmitting the processed command signals to the electronic device; and
a wiring scheme for communicating the command signals from the transmitter to the electronic device and physically coupling the control apparatus to the electronic device.

8. The control apparatus of claim 1 wherein the physical link layer comprises a wrist-mounted strap or clip-on attachment.

9. The control apparatus of claim 1 wherein the at least one sensor comprises an input interface whereby the user initiates a desired command on the input interface to be effectuated by the external electronic device and circuitry for detecting the desired command applied to the input interface and generating the appropriate signal in response thereto.

10. The control apparatus of claim 9 wherein the input interface comprises a joy-stick for applying forces in any of two dimensions to initiate a desired command.

11. The control apparatus of claim 9 wherein the input interface comprises a joy-stick for applying forces in any of three dimensions to initiate a desired command.

12. The control apparatus of claim 9 wherein the input interface comprises a track ball contact roller rotatable along two axes whereby a desired command is initiated by rotational movement of the roller.

13. The control apparatus of claim 9 wherein the input interface comprises a cylinder rotatable along an individual axis whereby a desired command is initiated by rotational movement of the cylinders.

14. The control apparatus of claim 1 further comprising software that processes the signal for operation with operating systems.

15. The control apparatus of claim 1 further comprising a data link layer which implements coding techniques to ensure that signals transmitted by a control apparatus do not interfere with signals transmitted by another control apparatus in close spacial proximity.

16. A control apparatus for implementing desired user commands on an electronic device in a secure environment, comprising:
a mounting frame for attachment to a portion of a user's hand;
at least one sensor coupled to the mounting frame for generating signals in response to user initiated input received by the sensor;
a physical link layer in communication with the sensor and interfaced with an electronic device, wherein the physical link layer receives, and performs processing on, signals generated by the sensor and transmits such processed signals to the electronic device to allow for control and navigation of such device, and
an authentication means for monitoring and controlling access to the electronic device.

17. The control apparatus of claim 16, wherein the physical link layer comprises:
a microcontroller in communication with the one or more sensors that receives command signals from the one or more sensors and performs control processing on the signals to ensure that the electronic device recognizes the command signal;
a radio frequency transmitter in communication with the microcontroller for transmitting the processed command signals to the electronic device;
an antenna in communication with the transmitter for transmitting the desired command signal to an electronic device located at a remote distance from the control apparatus;
a power source for providing electrical power to the components of the control apparatus; and
a mount for attachment to a user's body in a location remote from the mounting frame, wherein the antenna and power source are attached to the mounting means.

18. The control apparatus of claim 16, wherein the physical link layer comprises:
a microcontroller in communication with the one or more sensors that receives command signals from the one or more sensors and performs control processing on the signals to ensure that the electronic device recognizes the command signal;
an optical transmitter in communication with the microcontroller for transmitting the processed command signals to the electronic device through a generated optical signal;
a power source for providing electrical power to the components of the control apparatus; and
a mount for attachment to a user's body in a location other than where the mounting frame is located, wherein the power source is attached to the mounting means.

19. The control apparatus of claim 16 wherein the authentication means comprises an identification code embedded in the control apparatus and wherein the authentication means further includes a memory associated with the electronic device, the memory having at least one authorized identification corresponding thereto.

20. The control apparatus of claims 20 wherein the mount is a wrist-mounted strap.

21. A self-powered control apparatus for implementing a desired user command on an electronic device, the electronic device having a primary circuit, the self-powered control apparatus comprising:
a mounting frame for attachment to a portion of a user's hand;
at least one sensor coupled to the mounting frame for generating signals in response to user initiated input received by the sensor;
a physical link layer in communication with the sensor and interfaced with an electronic device, wherein the physical link layer receives, and performs processing on, signals generated by the sensor and transmits such processed signals to the electronic device to allow for control and navigation of such device, and
a secondary circuit associated with the control apparatus, the secondary circuit being electromagnetically coupled to the primary circuit of the electronic device such that as the secondary circuit is in proximity with the primary circuit, electric energy is transferred therebetween to provide power for the control apparatus.

22. The control apparatus of claim 21 wherein the self-powered control apparatus further comprises authentication means comprising an identification code embedded in the control apparatus.

23. A control apparatus for implementing desired stimulus commands on a user, comprising:
a mounting frame for attachment to a portion of a user's hand;
at least one transducer mounted to the mounting frame for generating stimulus in response to an initiated input received by the control apparatus; and
a physical link layer in communication with the at least one transducer and interfaced with an electronic device, wherein the physical link layer receives signals generated by the electronic device and transmits signals to the at least one transducer to initiate a desired stimulus.
